(19) United States
(12) Patent Application Publication
(10) Pub. No.: US 2012/0054079 A1
(43) Pub. Date: Mar. 1, 2012

(54) Charging system and charging method

(75) Inventor: Takeo Hayashi, Tokyo (JP)

(73) Assignee: NEC Corporation, Tokyo (JP)

(21) Appl. No.: 13/317,691

(22) Filed: Oct. 26, 2011

Related U.S. Application Data
(63) Continuation of application No. PCT/JP2010/067053, filed on Sep. 30, 2010.

(30) Foreign Application Priority Data
Sep. 30, 2009 (JP) 2009-227430

(51) Int. Cl. G06Q 30/04

(52) U.S. Cl. 705/34

(57) ABSTRACT

A charging system includes a communication network, a charging server which performs charge calculation to a communication in the communication network, and a management server which determines a network route for the communication and sets route information to network switches. The charging server stores charge class data every user. The management server sets the charge class data and the route information to a charging network switch optionally selected from network switches on the network route. The charging network switch performs the charge calculation by using the charge class data every time transferring a packet and generates the charged fee data. When the communication ends, the management server acquires the charged fee data from the charging network switch to transmit to the charging server.

### CROSS-REFERENCE TO RELATED APPLICATION

This application is a continuation of International Application No. PCT/JP2010/067053, filed on Sep. 30, 2010.

### TECHNICAL FIELD

The present invention relates to a charging system.

### RELATED ARTS

A charging system is known that charges a communication fee for use of a communication network to a terminal. In the charging system, conventionally, by arranging a unit that performs a charging process at a position through which all traffics transmitted through the communication network pass, flexible charging for various services has been carried out. The following techniques related to the charging system are disclosed.

Patent Literature 1 discloses a content use fee charging system that a use fee charged every time the content is used, is varied depending on an attribute assigned to a user. The content use fee charging system in Patent Literature 1 communicates with a user terminal through a network to perform processing and charging according to a request from the user terminal. The content use fee charging system is provided with a database, a request transmitting section, and a control section. The database stores attribute data and charged fee data of an individual member, to relate them to identification data on the member. A request receiving section receives the request from the user terminal. Upon reception of a service execution request, the control section uses identification data to perform terminal authentication, controls a content server to provide the service, determines a use fee on the basis of attribute data of a user, and adds the determined use fee to charged fee data. According to the content use fee charging system in Patent Literature 1, the use fee can be varied depending on a user attribute, and therefore, a use condition of the content can be validated to further increase the use fee for the content.

Also, Patent Literature 2 discloses a broadband access server that provides pay-as-you-go charging based on the number of delivered packets, the number of delivered bytes, and delivery data capacity for a delivery time, for each user, and thus, a viewing fee is differentiated on the basis of a bit rate of the delivered packet.

In the above-described conventional technique, at the position at which all traffics pass, e.g. immediate before a server providing contents, a charging process unit is arranged, and therefore it is effective in case of charging for a specific service or communication. However, it is not possible to apply the above technique to a communication network in which a specific position in which all traffics pass is not present. Also, it is difficult to apply the technique to an integrated charging process on a plurality of services.

### CITATION LIST

### Patent Literature

[Patent Literature 1]: JP 2002-189946A
[Patent Literature 2]: JP 2006-148750A

### Non-Patent Literature

[Non-Patent Literature 1]: “OpenFlow: Enabling Innovation in Campus Networks” by Nick Mckeown, et al., [online], Mar. 14, 2008.
The OpenFlow Switching Consortium, [searched on Sep. 29, 2009], <URL:http://www.openflowthe switch.org/documents/openflow-wp-latest.pdf>

### SUMMARY OF THE INVENTION

An object of the present invention is to provide a charging system that can perform a flexible charging process on all communications carried out in a communication network.

In one aspect, a charging system is provided with a communication network; a charging server that charges a communication in the communication network; and a management server that determines a network route for the communication to set route information on the network route to at least one of network switches on the network route as a charging network switch in the network. The charging server stores charge class data used to perform charge calculation for communication for each user, by relating it to the user. The management server sets charge class data for user as well as the route information to the charging network switch. Every time transfers a communication packet, the charging network switch performs the charge calculation by using the charge class data to generate charged fee data. Upon termination of the communication, the management server acquires the charged fee data from the charging network switch to transmit it to the charging server.

In another aspect, a charging process method is provided. The charging process method is used in a charging system that is provided with: a communication network; a charging server that charges for communication made in the communication network; and a management server that determines a network route for the communication to set route information on the network route for at least one network switch that forms the network route in the network. The charging server stores charge class information for performing charge calculation for communication for each user to be charged with relating it to the user. The charging process method is provided with the steps of: selecting a charging network switch from the at least one network switch; setting, for the charging network switch, along with the route information, charge class information corresponding to a user who makes communication; every time transferring a communication packet, performing the charge calculation using the charge class information to generate charged fee data; and upon termination of the communication, obtaining the charged fee data from the charging network switch to transmit it to the charging server.

According to the present invention, a charging system that can perform a flexible charging process on all communications in a communication network can be provided.

### BRIEF DESCRIPTION OF THE DRAWINGS

The above and other objects, effects, and features of the present invention will be further clarified from description of exemplary embodiments in conjunction with the following drawings:

FIG. 1 is a diagram showing a configuration of a charging system in a first exemplary embodiment;

FIG. 2 is a diagram showing a configuration of a the switch 102 in the first exemplary embodiment;

FIG. 3 is a diagram showing an example of a flow table 204 in the first exemplary embodiment;

FIG. 4 is a diagram showing a configuration of a management server 105 in the first exemplary embodiment;

FIG. 5 is an operation flow of the charging system in the first exemplary embodiment;

FIG. 6 is an operation flow of the management server 105 in the first exemplary embodiment;

FIG. 7 is a diagram showing a configuration of the management server 105 in a second exemplary embodiment;

FIG. 8 is a diagram showing an example of a charge management table 501 in the second exemplary embodiment; and

FIG. 9 is an operation flow of the management server 105 in the second exemplary embodiment.

### DESCRIPTION OF EXEMPLARY EMBODIMENTS

Hereinafter, a charging system of the present invention will be described with reference to the attached drawings.

### First Exemplary Embodiment

First, the charging system according to a first exemplary embodiment of the present invention will be described.

In the charging system of the present exemplary embodiment, when communication is started in a communication network, a (network) management server sets route information to network switches in the communication network to configure a network route. At this time, at the same time as the setting of the route information, the management server sets a user of the communication and a charge class for the user to one network switch which is optionally selected from the network switches on the communication rout. The charge class is used for charge calculation. The selected network switch stores the route information for the network route, the communication user, and the charge class in units of network routes for every communication flow.

Also, every time transferring a packet, the selected network switch carries out the charge calculation by using the charge class (flow-dependent charge class) specified based on the communication flow to which the packet belongs, and outputs the calculation result as charged fee data. Upon termination of the communication, the selected network switch transmits the charged fee data to the management server. The management server transfers the received charged fee data to the charging server. As described above, in the charging system of the present exemplary embodiment, the charge calculation is carried out by an optional network switch on a network route for a specific communication flow. Thus, it is possible to carry out flexible charging in units of packets or in units of bytes for each of the communication flows set in the communication network.

### <Configuration>

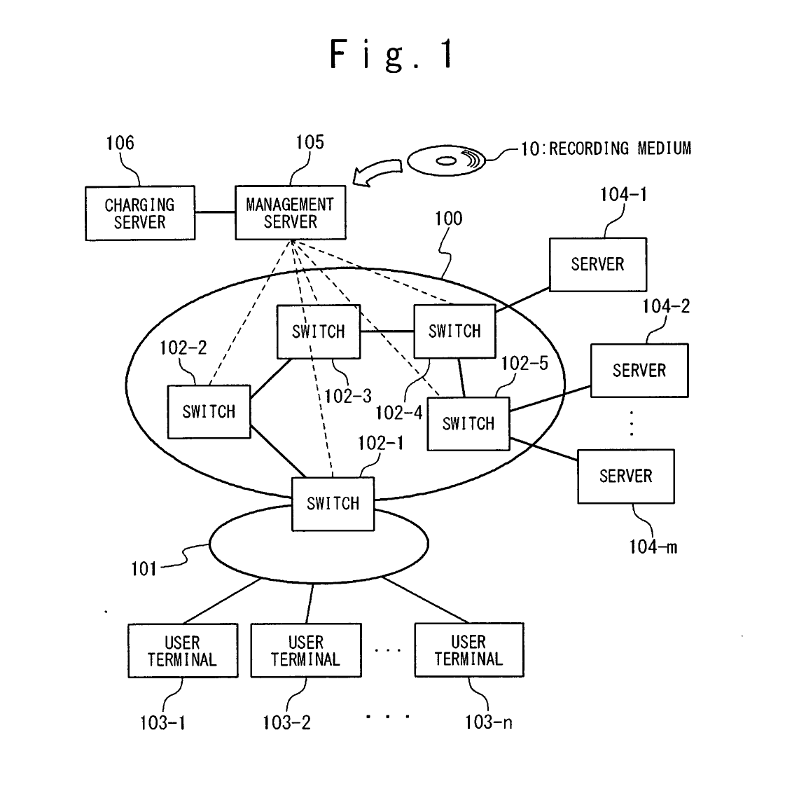

First, a configuration of the charging system in the present exemplary embodiment will be described. FIG. 1 is a block diagram showing the configuration of the charging system in the present exemplary embodiment. The charging system of the present exemplary embodiment is provided with network switches (hereinafter, to be referred to as switches) 102-1 to 102-5, user terminals 103-1 to 103-n, servers 104-1 to 104-m, a network management server (hereinafter, to be referred to as a management server) 105, and a charging server 106. It should be noted that in the following description, sometimes, the switches 102-1 to 102-5 are referred to as switches 102, user terminals 103-1 to 103-n as user terminals 103, and the servers 104-1 to 104-m as servers 104.

The (communication) network 100 is configured from the switches 102. It should be noted that the communication network 100 may be configured from more (or less) switches 102. A network 101 is a communication network provided with network switches and network routers (not shown). It should be noted that the network 100 and the network 101 are connected to each other through the switch 102-1.

The network 100 of the present exemplary embodiment is applied with a communication system based on OpenFlow. In an OpenFlow network, communication is recognized not in units of packets but in units of flows. It should be noted that a communication flow is identified based on a combination of MAC addresses, IP addresses, and port numbers for a source and a destination. Upon reception of a first packet (e.g. TCPSYN packet) when any of user terminals 103 starts a communication, each of the switches 102-1 to 102-5 in the OpenFlow-based network 100 issues an inquiry to the management server 105, if a network route for the packet is not retained therein. Upon reception of the inquiry from any of the switches 102, the management server 105 determines the network route for the packet, and sets the determined route information to the switches 102 on the network route. Each of the switches 102 transfers the received packet based on the route information set by the management server 105 to a next one of the switches 102. For more detailed technical matters on OpenFlow, Non-patent Literature 1 should be referenced.

Also, the network 101 is an intra-network as represented by a LAN (Local Area Network). It should be noted that the network configuration as shown in FIG. 1 is only an example, and the network 100 may be connected with more networks having various configurations.

Each of the servers 104-1 to 104-m provides information to the user terminals 103-1 to 103-n. A type of information provided by the server 104 is not particularly limited. The server 104 provides various types of information such as a Web server, a mail server, and an application server. The server 104-1 is connected to the switch 102-4. The servers 104-2 to 104-m are connected to the switch 102-5. It should be noted that a connection relation between the servers 104 and the switches 102 in the network 100 is only an example, and not limited to this connection relation.

Each of the user terminals 103-1 to 103-n is used by the user. The user terminal includes an information terminal connected to a communication network to carry out data communication such as a personal computer. The user terminals 103 are connected to the network 101. Each of the terminals 103 carries out a data communication with any of the servers 104 through the networks 101 and 100 to obtain information from the servers 104.

Each of the switches 102 transfers a packet. The switches 102-1 to 102-5 are respectively connected to the management server 105. The route information for the communication flow is set to each of the switches 102-1 to 102-5 by the management server 105. Each of the switches 102-1 to 102-5 transfers the received packets to a next one thereof based on the route information. It should be noted that in FIG. 1, the switches 102-1 to 102-5 are connected in series. However, this is only an example, and a connection relation among the switches 102-1 to 102-5 is not limited to this.

Also, each of the switches 102 stores data such as charge class necessary for a charge calculation. The data necessary for the charging process is set to any of the switch 102-1 to 102-5 by the management server 105 along with the route information for every communication flow. Every time transferring one packet, each of the switches 102-1 to 102-5 carries out the charge calculation to generate charged fee data. Upon termination of the communication, the switch transmits the charged fee data to the management server 105.

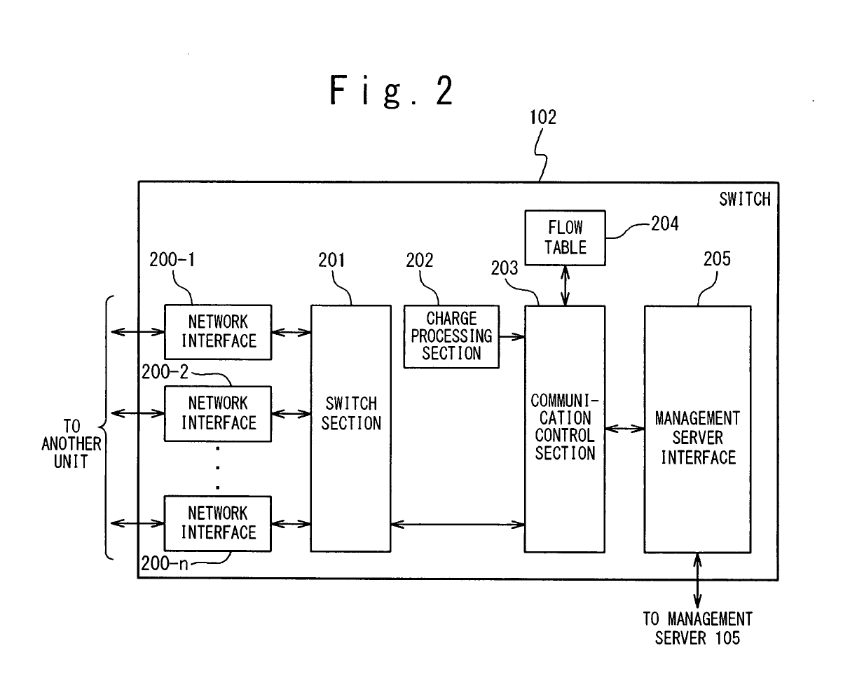

FIG. 2 is a diagram showing a configuration of the switch 102 in the present exemplary embodiment. It should be noted that the switches 102-1 to 102-5 have the same configuration. The switch 102 of the present exemplary embodiment is provided with network interfaces (hereinafter, to be referred to as network interfaces) 200-1 to 200-n, a switch section 201, a charge processing section 202, a communication control section 203, a flow table 204, and a management server interface (hereinafter, to be referred to as a management server IF) 205.

Each of the interface network interfaces 200 (200-1 to 200-n) is a physical interface that connects by a link to another switch 102 or another unit. The switch section 201 connects between the interfaces network interface 200-1 to 200-n to transfer a packet. The flow table 204 stores the route information for every communication flow, including a transmission destination of the received packet. The communication control section 203 solves the transfer destination of the received packet by referring to the flow table 204. Thus, the communication control section 203 provides a flow solution. The communication control section 203 controls the switch section 201 based on the solved transfer destination of the packet such that packet is transferred toward the destination. The charge processing section 202 executes the charge calculation on the basis of the number of transferred packets or bytes. The management server interface (IF) 205 is a physical interface connected to the management server 105.

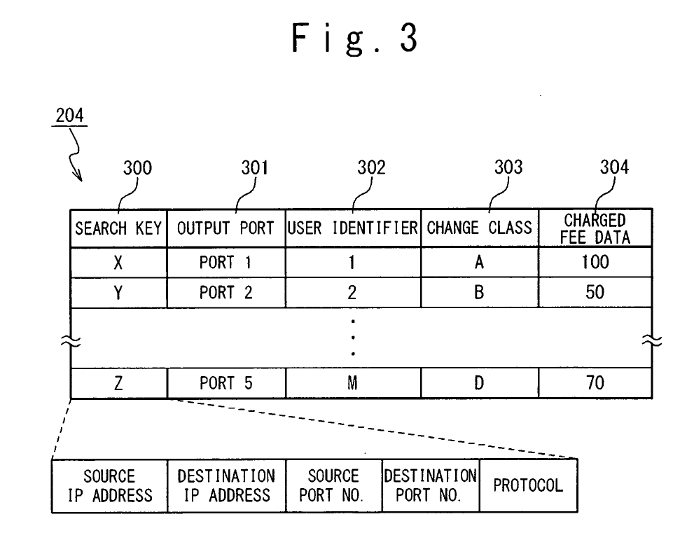

FIG. 3 is a diagram showing an example of the flow table 204 in the present exemplary embodiment. The flow table 204 in the present exemplary embodiment stores a search key 300, an output port 301, a user identifier 302, a charge class 303, and charged fee data 304.

First, the search key 300 is used to refer to a header of the received packet to specify a communication flow. The search key 300 indicates a source IP address, a destination IP address, a source port number, a destination port number, and a protocol. The source IP address indicates an IP address of a transmission source of the packet. The destination IP address indicates an IP address of a destination of the packet. The source port number indicates a port number of a transport protocol of the transmission source of the packet. The destination port number indicates a port number of a transport protocol of the destination of the packet. The protocol indicates a protocol number of a network protocol. It should be noted that the information contained in the search key 300 is only an example, and not limited to the content if a communication flow can be uniquely specified.

The output port 301 indicates an interface number of one of network interface 200-1 to 200-n which outputs the received packets. For example, port 1 corresponds to the network interface 200-1. It should be noted that a storage format of the output port 301 is not limited to this. The output port 301 may directly indicates a number of one of the network interfaces 200. The user identifier 302 indicates an identifier for uniquely identifying the user of the communication flow. The charge class 303 indicates an amount of money per packet or amount of charged money per byte. The charge class 303 is data that varies depending on a service that the user subscribes. The charged fee data 304 indicates data after the charge calculation for every communication flow. It should be noted that the charge class 303 is not limited to units such as the packet unit or the byte unit, and may be provided on the basis of another unit to determine an amount of money.

Next, returning to FIG. 1, the management server 105 sets the route information for the communication flow for the packet to the switches 102-1 to 102-5. The management server 105 is connected to the switches 102-1 to 102-5. The management server 105 acquires the connection relation among the switches 102-1 to 102-5 in the network 100 from the switches 102-1 to 102-5. When being requested to achieve a route solution by the switches 102, the management server 105 determines the network route in the network 100 and sets the network route to the switches 102-1 to 102-5. Also, the management server 105 is connected to the charging server 106. Upon reception of a solution request of a charge class from the switches 102, the management server 105 acquires the charge class from the charging server 106 and responds to the switches 102-1 to 102-5. Also, the management server 105 transfers the charged fee data received from the switches 105-1 to 105-2 to the charging server 106.

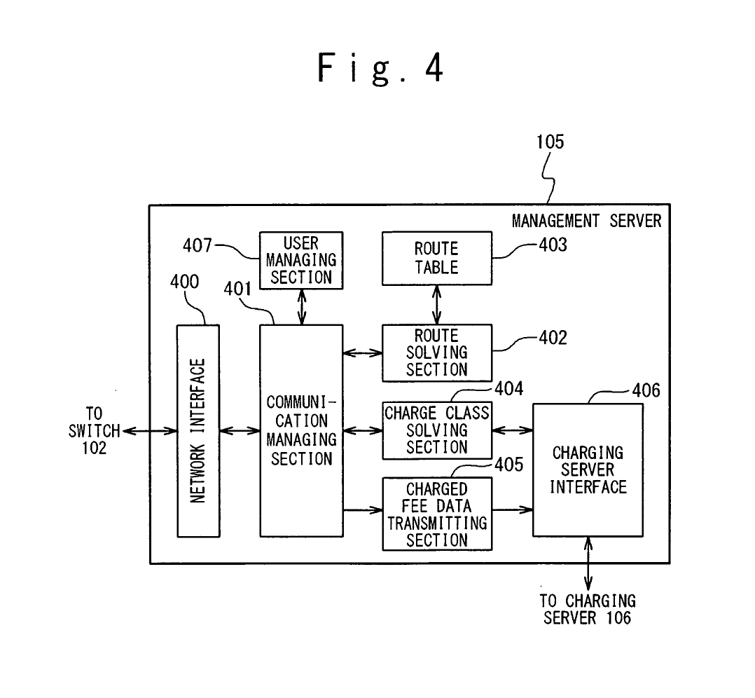

FIG. 4 is a block diagram showing a configuration of the management server 105 in the present exemplary embodiment. The management server 105 of the present exemplary embodiment is provided with a switch interface (hereinafter, to be referred to as a the switch IF) 400, a communication managing section 401, a route solving section 402, a route table 304, a charge class solving section 404, a charged fee data transmitting section 405, a charging server interface (hereinafter, to be referred to as a charging server IF) 406, and a user managing section 407.

The switch interface 400 is a physical interface to each of the switches 102. The communication managing section 401 controls the management server 105. The route table 403 stores the connection relation among the switches 102 in the network 100. Upon reception of a route solving request (a solution request) from any of the switches 102, the route solving section 402 refers to the route table 403 to acquire a route solution. The charging server interface 406 is a physical interface connected to the charging server 106. Upon reception of a charge class solving request (a solution request) from any of the switches 102, the charge class solving section 404 issues an inquiry about a charge class to the charging server 106 through the charging server interface 406. The charged fee data transmitting section 405 transmits the charged fee data received from any of the switches 102 through the charging server interface 406. The user managing section 407 stores a portion of the header information of the packet by relating it to a user identifier that uniquely specifies a user. The portion of the header information of the packet is, for example, a source IP address, or VLAN (Virtual) ID. The user identifier can uniquely identify the user. The user identifier is shared with the charging server 106. In the network 100, a plurality of users carry out communications, and therefore the user managing section 407 stores a plurality of sets of header information and user identifier.

Next, returning to FIG. 1, the charging server 106 charges each of the users on the basis of data for the charge calculation received from the management server 105. The charging server 106 stores the charge class of the received data for the charge calculation. The charge class indicates a fee per packet or a fee per byte of transfer data. The charge class is set for every user by an administrator of a charging system based on a service that the user subscribes. Upon reception of a request from the management server 105, the charging server 106 transmits the charge class to the management server 106.

It should be noted that the configurations of the switches 102 and management server 105 may be realized in hardware or software, or a combination of them. In case of realization in software, the configurations are realized by processors executing computer programs incorporated in the switches 102 and management server 105. Such a computer program is retained in a recording medium 10 shown in FIG. 1. The recording medium 10 is exemplified by a CD (Compact Disc), or HDD (Hard Disk Drive) of an application server. The computer program may be introduced from a computer directly connected to the switches 102 or the management server 105, or an application server through a network (not shown).

### <Operation>

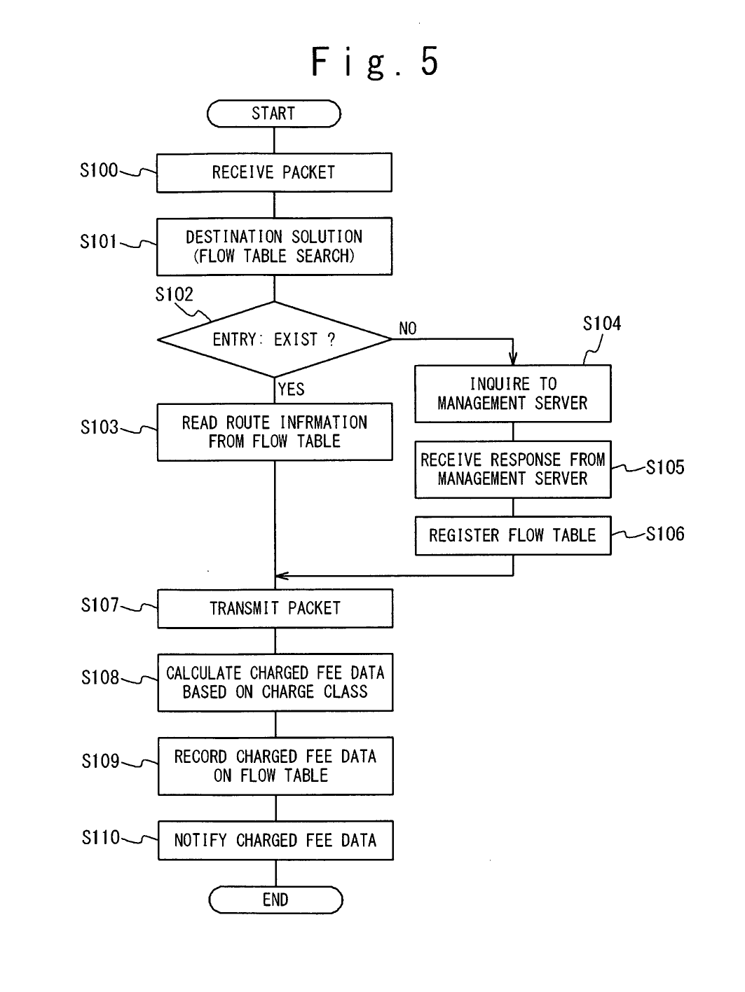

Next, an operation of the charging system in the present exemplary embodiment will be described. First, FIG. 5 is a control operation of the charging system in the present exemplary embodiment. It should be noted that the description is made by using a communication between the user terminal 103-1 and the server 104-1 as an example. Also, it is assumed that the charge class is set to the switch 102-1 among the switches 102 on a network route.

### Step S100:

The switch 102-1 receives a packet. Specifically, the user terminal 103-1 starts communication with the server 104-1 to transmit the packet onto the network 101. The switch 102-1 receives the packet from the user terminal 103-1 through the network 101.

### Step S101:

The communication control section 203 of the switch 102-1 performs a destination solution of the packet. Specifically, when any of the network interfaces 200 receives the packet, the communication control section 203 of the switch 102-1 obtains header information of the packet, and refers to the flow table 204 based on the header information to determine one of the network interfaces 200 related to a destination of the packet.

### Step S102:

The communication control section 203 of the switch 102-1 determines whether or not a record of the route information corresponding to the header information of the packet is present in the flow table 204. Specifically, the communication control section 203 determines whether or not data corresponding to the header information of the packet is present in the search key 300 of the flow table 204. If the route information record is present, the control operation proceeds to Step S103. On the other hand, if the route information record is not present, the control operation proceeds to Step S104.

### Step S103:

The communication control section 203 of the switch 102-1 reads the record of route information from the flow table 204. Specifically, if the record of the route information corresponding to the header information of the packet is present in the flow table 204, the communication control section 203 reads the route information record from the flow table 204. Subsequently, the control operation proceeds to Step S107.

### Step S104:

The communication control section 203 of the switch 102-1 issues an inquiry about the route information to the management server 105. Specifically, if the record of route information corresponding to the header information of the packet is not present in the flow table 204, the communication control section 203 issues a route solving request through the management server interface 205. Upon reception of the route solving request from the switch 102-1, the management server 105 acquires a route solution to perform the network route setting to the switches 102. Further, at the same time as the network route setting, the management server 105 sets a charge class corresponding to the communication flow to the switch 102-1. It should be noted that the operation of the management server 105 in this step will be described later in detail.

### Step S105:

The communication control section 203 of the switch 102-1 receives a response to the route solving request from the management server 105 through the management server interface 205.

### Step S106:

The communication control section 203 of the switch 102-1 stores in the flow table 204, the route information and the charge class contained in the response from the management server 105. It should be noted that the route information is also set to the switches 102 on the network route by the management server 105.

### Step S107:

The switch 102-1 outputs the packet to one of the network interfaces 200-1 to 200-n that is used for the output. Specifically, the communication control section 203 determines an output interface of the network interfaces 200 to be used for output of the packet on the basis of the route information corresponding to the header information of the received packet. The communication control section 203 notifies the determined network interface 200 to the switch section 201. When sensing the determined network interface 200, the switch section 201 controls a connection between the network interfaces 200 for the packet. The network interface 200 transfers the packet. In this operation, when the packet is received by the network interface 200-1 and then the network interface to be used for output is determined to be the network interface 200-2 by the communication control section 203, a connection between the network interface 200-1 and the network interface 200-2 is established, and then the packet is transmitted from the network interface 200-2. It should be noted that the setting of the network route (e.g., network route through the switches 102-1 to 102-4) between the user terminal 103-1 and the server 104-1 has already been made by the management server 105, and therefore the packet is transferred by the switches (in this case, the switches 102-1 to 102-4) on the network route to arrive at the server 104-1.

### Step S108:

The charge processing section 202 of the switch 102-1 carries out charge calculation on the basis of the charge class to generate charged fee data. Specifically, the charge processing section 202 carries out the charge calculation on the basis of the charge class corresponding to the route information read from the flow table 204. As described above, the charge class indicates a fee per packet or byte. The charge processing section 202 multiplies the number of transferred packets or the number of bytes of the packet by a fee per unit to calculate the charged fee data.

### Step S109:

The charge processing section 202 indicates the calculated charged fee data in the flow table 204.

### Step S110:

Upon completion of the communication, the charge processing section 202 notifies the charged fee data to the management server 105. Specifically, when the communication between the terminal 103-1 and the server 104-1 is completed, the charge processing section 202 reads the charged fee data from the flow table 204, and transmits a termination notice including the charged fee data to the management server 105 through the communication control section 203 and the management server interface 205. The management server 105 notifies the charged fee data received from the switch 102-1 to the charging server 106.

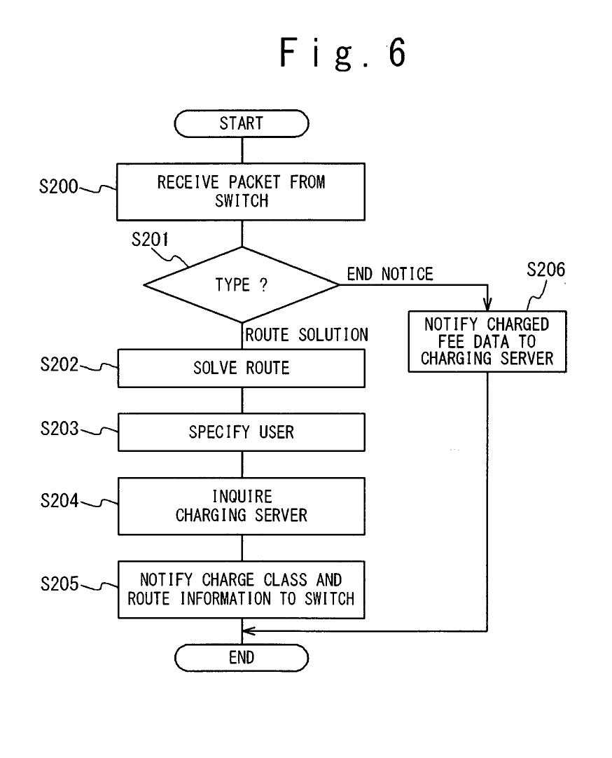

Next, the operation of the management server 105 in the present exemplary embodiment will be described. FIG. 6 is a flowchart showing an operation of the management server 105 in the present exemplary embodiment. It should be noted that the Step S104 of FIG. 5 will be described in detail.

### Step S200:

The communication managing section 401 of the management server 200 receives the packet from the switch 102-1 through the switch IF 400.

### Step S201:

The communication managing section 401 determines a type of the received packet. In general, the communication managing section 401 determines the type of the packet based on a portion of the header information of a packet or a payload of the packet. If the type of the packet is the route solving request, the control operation proceeds to Step S202. On the other hand, if the type of the packet is the termination notice, the control operation proceeds to Step S206.

### Step S202:

In case that the type of the received packet is the route solving request, the route solving section 402 determines a route solution. Specifically, the route solving section 402 refers to the route table 403 to acquire the route solution by use of the route solving request. The route solving section 402 determines the network route in the communication network 100 on the basis of the acquired solution (information of the received packet). In this description, the network route through the switches 102-1, 1-2-2, 102-3, and 102-4 is determined.

### Step S203:

The user managing section 407 specifies a user who performs the communication. The user managing section 407 stores a portion of the header information of the packet and a user identifier uniquely specifying the user, by relating them to each other. The header information portion of the packet is a source IP address or VLAN ID, as described above. Also, the user identifier can be used to uniquely identify the user, as described above. The user managing section 407 specifies the user identifier on the basis of the header information portion of the received packet, such as the source IP address or VLAN ID.

### Step S204:

The charge class solving section 404 issues an inquiry about the charge class to the charging server 106. Specifically, the charge class solving section 404 uses the user identifier specified by the user managing section 407 to issue the inquiry a charge class corresponding to the user identified by the user identifier through the charging server interface 406 to the charging server 106. The charging server 106 extracts a charge class corresponding to the user identifier from preliminarily stored charge classes, and responds to the management server 105.

### Step S205:

The communication managing section 401 notifies the route information and charge class to the switches 102. Specifically, the communication managing section 401 notifies to the switches 102-1 to 102-4 on the network route, the route information determined by the route solving section 402, and the charge class obtained by the charge class solving section 404. It should be noted that the charge class is notified only to the switch 102-1. Upon reception of the route information and charge class from the management server 105, the switch 102-1 stores the route information and charge class in the flow table 204. Also, upon reception of the route information from the management server 104, the switches 102-2 to 102-4 store the route information in the flow table 204. In this manner, the network route through the switches 102-1 to 102-4 in the communication network 100 is set.

### Step S206:

If the type of the received packet is the termination notice, the charged fee data transmitting section 405 transmits the charged fee data of the termination notice to the charging server 106 through the charging server interface 406.

According to the charging system of the present exemplary embodiment, the charge class for the user of the communication flow is set to an optional switch 102-1 among the switches 102-1 to 102-4 set as the network route for the specific communication flow in the network 100. Thus, it becomes possible to perform charging per packet or byte for each of the communication flows. For this reason, flexible charging can be performed for the communications in all the communication flows in the communication network. It should be noted that in the above description, the charge class is set to the switch 102-1. However, the charge class may be set to any of the switches 102-1 to 102-4 of the network route for the same communication flow.

The management server 105 grasps a network route for a specific communication flow, and therefore may change the charge class to be set to the switch 102-1 in consideration of the network route. For example, if the network route is a highly reliable route, the management server 105 can increase the charge class to increase a predetermined charge per unit, or if the network route is crowded, the management server 105 can decrease the predetermined charge per unit as a discount.

Also, in the present exemplary embodiment, the charging process performed on the communication between the user terminal 103-1 and the server 104-1 has been described. However, regarding communication between the user terminals 103-1 to 103-n and the server 104-1 to 104-m, the charging process can be performed in the same manner.

### Second Exemplary Embodiment

Next, the charging system according to a second exemplary embodiment of the present invention will be described.

In the charging system of the present exemplary embodiment, a network management server sets a user of communication and a charge class for charge calculation, to all the network switches present on the network route for a communication flow, at the same time as the setting of route information. Every time each of the network switches on the network route transfers a packet, the network switch performs the charge calculation to generate charged fee data by use of the charge class. Then, upon termination of the communication, each of the network switches transmits the charged fee data to the network management server. The network management server memorizes for each user, which of the network switches in a network the charge class is set to. Upon reception of the charged fee data from the network switches for a user, the network management server transfers a total charged fee data as a summation of the received charged fee data to the charging server. By Such a configuration, flexible charging is provided for every communication flow to all communication flows set in the communication network. Also, even to a plurality of communication flows, the charged fee data can be managed for each user.

### <Configuration>

First, the configuration of the charging system in the present exemplary embodiment will be described. The charging system of the present exemplary embodiment has almost the same configuration as that of the first exemplary embodiment. For this reason, a difference from the first exemplary embodiment and the present exemplary embodiment will be described. Also, the same components as those in the first exemplary embodiment are assigned to the same symbols or abbreviations.

The charging system of the present exemplary embodiment is different from that of the first exemplary embodiment in configuration of the management server 105. The configurations of the switches 102, the user terminals 103, the servers 104, and charging server 106 are the same as those in the first exemplary embodiment. Also, the networks 100 and 101 are the same as those in the first exemplary embodiment.

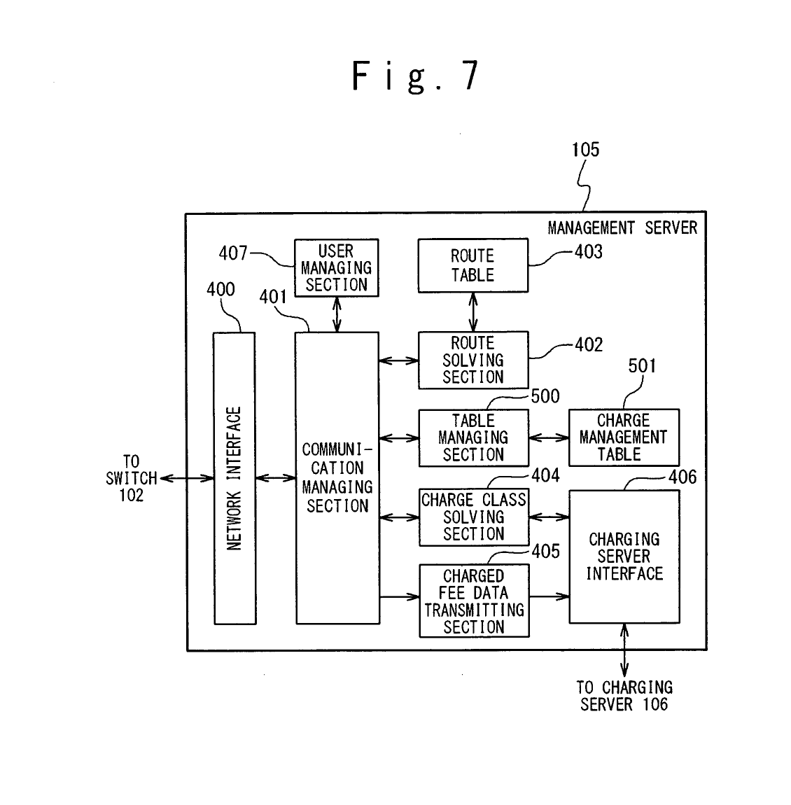

With reference to FIG. 7, the configuration of the management server 105 in the present exemplary embodiment will be described. As in the first exemplary embodiment, the management server 105 in the present exemplary embodiment is provided with the switch interface 400, the communication managing section 401, the route solving section 402, the route table 403, the charge class solving section 404, the charged fee data transmitting section 405, the charging server interface 406, and the user managing section 407. In the present exemplary embodiment, the management server 105 is further provided with a table managing section 500 and a charge management table 501. It should be noted that the switch interface 400, the communication managing section 401, the route solving section 402, the route table 403, the charge class solving section 404, the charged fee data transmitting section 405, the charging server IF 406, and the user managing section 407 are the same as those in the first exemplary embodiment.

First, the charge management table 501 stores data for managing the switches 102 as objects of a charging process. The table managing section 500 accesses to the charge management table 501 to obtain the data from the charge management table 501 and stores the data in the charge management table 501.

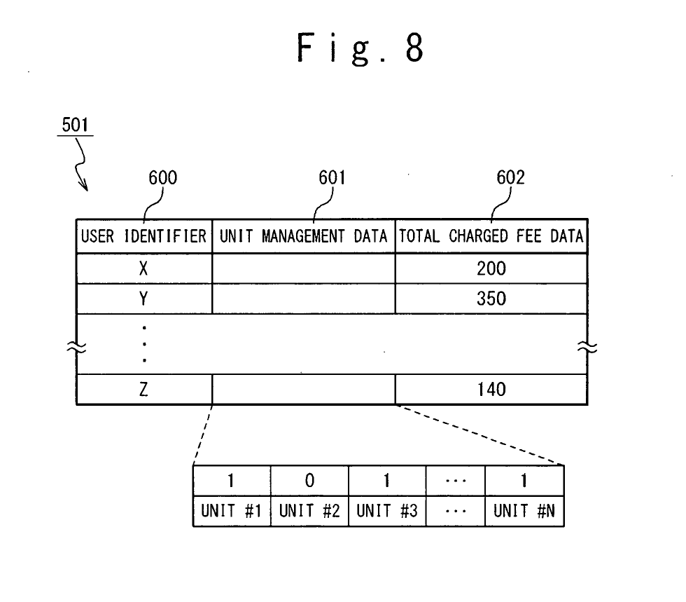

FIG. 8 is a diagram showing an example of the charge management table 501 in the present exemplary embodiment. The charge management table 501 retains a user identifier 600, a unit management data 601, and total charged fee data 602, by relating them to one another in a record.

The user identifier 600 is used to uniquely identify a user. The unit management data 601 indicates which of the switches 102-1 to 102-5 in the network 100 is requested to perform a charging process.

The unit management data 601 is provided with count fields corresponding to units #1 to #N, as shown below FIG. 8. The units #1 to #N correspond to the switches 102-1 to 102-5 in the network 100. For example, in FIG. 8, the count of “1” is held in the units #1, #3, and #N. This means that a once charging process is requested to each of the units. On the other hand, the count of “0” is held in the unit #2. This means that this unit is not requested to perform the charging process. For example, when communication is terminated and the termination notice is received from the unit #1 (e.g., the switch 102-1), the table managing section 500 updates the count of the unit #1 to “0”. That is, when any of the switches 102 is requested to perform the charging process, the table managing section 500 increments by “1”, the count of the unit corresponding to the switch 102 that requested to perform the charging process. Upon reception of the termination notice, the count of the unit corresponding to the switch 102 that issued the termination notice is decremented by “−1”. In this manner, it can be determined from the unit management data 601 which of the switches 102-1 to 102-5 in the network 100 and how many times the charging processes are requested.

The total charged fee data 602 indicates a total of the charged fee data contained in the termination notices from the switches 102-1 to 102-5 that have requested to perform the charging processes. The total charged fee data 602 is updated by the table managing section 500 every time the termination notice is received. It should be noted that a record is generated in the charge management table 501, for each user identifier.

### <Operation>

Next, the operation of the charging system in the present exemplary embodiment is almost the same as that of the first exemplary embodiment. The charging system in the present exemplary embodiment is different from the first exemplary embodiment in the operation of the management server 105. For this reason, the operation of the management server 105 will be mainly described and the rest of the operation, only a relevant portion will be described.

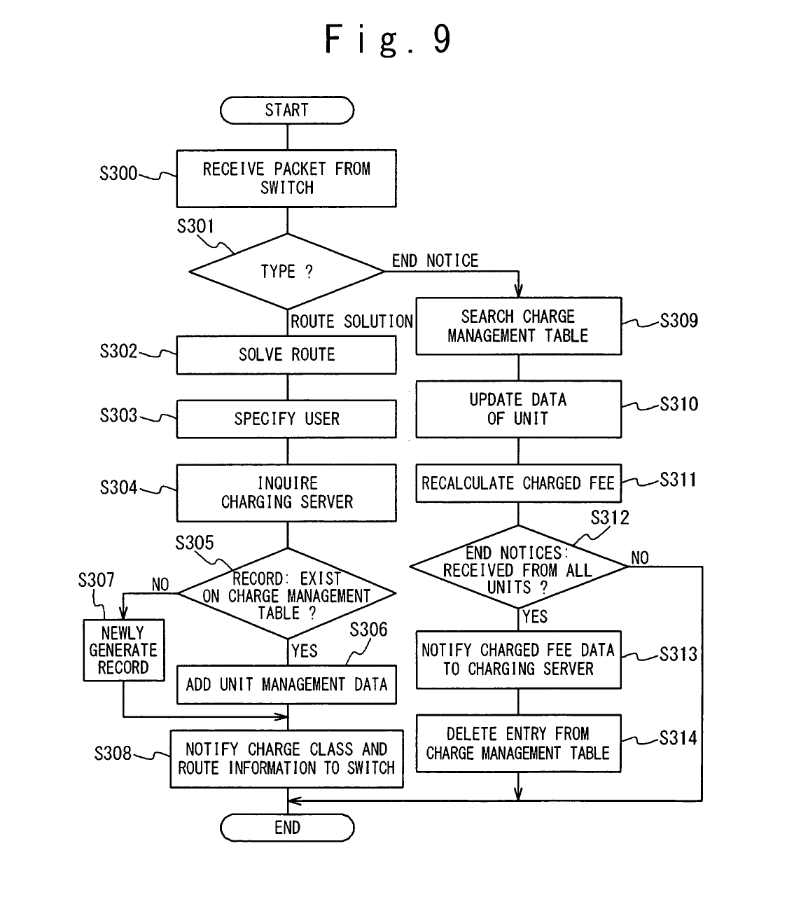

FIG. 9 is an operation flow of the management server 105 in the present exemplary embodiment. A case where communication is carried out between the user terminal 103-1 and the server 104-1 in FIG. 1 will be described as an example.

### Steps S300 to S304:

Steps S300 to S304 are the same as Steps S200 to S204 in FIG. 6, and therefore the description thereof is omitted. That is, the communication managing section 401 of the management server 200 receives a packet from the switch 102-1 (Step S300). The communication managing section 401 determines a type of the received packet (Step S301). If the type of the packet is the route solving request, the control operation proceeds to Step S302, whereas if the type of the packet is the termination notice, the control operation proceeds to Step S309. At Step 302, the route solving section 402 carries out a route solution. The user managing section 407 specifies the user (Step S303). The charge class solving section 404 issues an inquiry about a charge class to the charging server 106 (Step S304).

### Step S305:

The table managing section 500 determines whether or not a record corresponding to a user identifier is present in the charge management table 501. Specifically, the communication managing section 401 notifies to the table managing section 500, the route information determined by the route solving section 402, the charge class acquired by the charge class solving section 404, and the user identifier specified by the user managing section 407. The table managing section 500 determines whether or not the user identifier identical to the user identifier is already recorded in the charge management table 501. If the record corresponding to the user identifier is present, the control operation proceeds to Step S306. On the other hand, if the record corresponding to the user identifier is not present, the control operation proceeds to Step S307.

### Step S306:

When the record corresponding to the user identifier is present in the charge management table 501, the table managing section 500 updates the unit management data 601 based on the route information. Specifically, among respective unit flags of the unit management data 601, the units corresponding to the switches 102-1 to 102-4 contained in the route information are incremented by “1”.

### Step S307:

If the record corresponding to the user identifier is not present in the charge management table 501, the table managing section 500 generates a record corresponding to the user identifier which is specified by the user managing section 407. Specifically, in a record of the user identifier 600 which is newly recorded in response to the user identifier, the units corresponding to the switches 102-1 to 102-4 contained in the route information among the respective unit flags of the unit management data 601 are incremented by “1”, and the total charged fee data 602 is recorded as the initial value of “0”.

### Step S308:

When the registration into the charge management table 501 by the table managing section 500 is completed, the communication managing section 401 notifies the route information and the charge class to the switches 102-1 to 102-4 on the network route. Specifically, in the present exemplary embodiment, the communication managing section 401 notifies the route information and the charge class to all of the switches 102-1 to 102-4 on the'network route. That is, in this description, the communication managing section 401 notifies the route information and the charge class to all of the switches 102-1 to 102-4 on the network route in the communication network 100 between the user terminal 103-1 and the sever 104-1. Upon reception of the route information and the charge class from the management server 105, each of the switches 102-1 to 102-4 stores the route information and the charge class in the flow table 204. In this manner, the network route through the switches 102-1 to 102-4 in the communication network 100 is set. In this case, the control operation is terminated. Subsequently, in each of the switches 102, every time a packet is transferred, the charge calculation is carried out. Then, when the management server 106 receives the packet from any of the switches 102-1 to 102-4, the control operation is restarted.

### Step S309:

When the type of the packet is the termination notice, the communication managing section 401 instructs the table managing section 500 to search a record corresponding to a user identifier in the termination notice in the charge management table 501.

### Step S310:

The table managing section 500 updates the record corresponding to the user identifier of the termination notice. Specifically, the table managing section 500 reads the record corresponding to the user identifier in the termination notice, and updates unit management data 601 corresponding to any of the switches 102-1 to 102-4 that issued the termination notice. The number of times of the request of the charging process given to each switch is recorded in the unit management data 601. In the record for the user identifier of the termination notice, the table managing section 500 decrements by “−1”, values in the count fields of the units #1 to #N in the unit management data 601 corresponding to the switch 102 that issued the termination notice.

### Step S311:

The table managing section 500 updates the total charged fee data 602 of the record corresponding to the user identifier in the termination notice, on the basis of charged fee data of the termination notice. Specifically, the table managing section 500 adds the charged fee data of the termination notice to the total charged fee data 602 in the record corresponding to the user identifier of the termination notice.

### Step S312:

The table managing section 500 determines whether or not termination notices have been received from all of the switches 102, in the record corresponding to the user identifier of the termination notice. Specifically, upon completion of the update of the charge management table 501 based on the termination notice, the table managing section 500 determines whether or not the respective count fields of the units #1 to #N in the unit management data 601 are all “0” in the record corresponding to the user identifier. If the respective count fields of the units #1 to #N in the unit management data 601 are all “0”, this means that in all of the switches 102 in the network 100, the charging process corresponding to the user identifier is not currently carried out, i.e., communication for a communication flow corresponding to the user identifier is not carried out. If the termination notices have been received from all of the switches 102, the control operation proceeds to Step S313. On the other hand, if the termination notice is not received from any of the switches 102, the control operation is terminated. Subsequently, when the management server 106 receives the packet from any of the switches 102, the control operation is restarted.

### Step S313:

If the termination notices have been received from all of the switches in the record corresponding to the user identifier of the termination notice, the charged fee data transmitting section 405 transmits the total charged fee data corresponding to the user identifier to the charging server 106 through the charging server interface 406.

### Step S314:

When the total charged fee data in the record corresponding to the user identifier in the termination notice is notified to the charging server 106, the table managing section 500 deletes the record corresponding to the user identifier. In this manner, the charged fee data calculated for the respective the switches 102 can be totalized in the management server 105 and the total charged fee data is notified to the charging server 106. Thus, the control operation is ended.

As described above, the operation of the management server 105 in the present exemplary embodiment has been described. In this description, the charging process in the communication between the user terminal 103-1 and the server 104-1 has been described. However, regarding communication between any of the user terminals 103-1 to 103-n and any of the servers 104-1 to 104-m, the charging process can be carried out in the same manner.

According to the charging system of the present exemplary embodiment, the charge class is set to all the switches 102 on the network route for the specific communication flow, and the charge calculation is performed in all of the switches 102. For this reason, in all of the switches 102 present in the network 100, the charge calculation can be performed, and the charging process can be performed even on a service through any network route, in which traffic is not concentrated on a specific route in the network 100.

The management server 105 knows the network route for the specific communication flow, and therefore may change the charge class to be set to the switch 102-1 on the network route for the specific communication flow in consideration of the network route or performance of each the switch. For example, if the switch has high processing performance, or the network route is a highly reliable route, the management server 105 can change the charge class to increase a predetermined charge per unit, or if the switch has low processing performance or the network route is crowded, the management server 105 can decrease the predetermined charge per unit. For this reason, the flexible charging can be provided depending on performance or reliability of the network resources of the network. It should be noted that such a change in the charge class may be carried out for each switch 102. Thus, more flexible charging can be provided.

In addition, for example, in case where the user terminal 103-1 communicates with the server 104-2 through the server 104-1, the charging can be provided under the integrated management of these communications. In this case, it can be determined by the following method that the communication between the user terminal 103-1 and the server 104-1 and the communication between the server 104-1 and the server 104-2 are performed by the same user. In case where only the specific user uses the server 104-1, it is only necessary for the management server 105 to store a correspondence relation between an identifier specifying the server 104-1 such as an IP address, and a user identifier of the user. Also, in case where the server 104-1 is shared by a plurality of users by use of a virtual machine, it is only necessary for the management server 105 to store the correspondence relation between the identifier specifying the virtual machine such as an IP address and user identifiers of the users. If a preferred identifier is not present, it is only necessary for the switch 102 to determine a unique identifier to notify to the management server 105 by a packet.

In the above, the present invention has been described with reference to the exemplary embodiments. However, the present invention is not limited to the above-described exemplary embodiments. A person skilled in the art can carry out various modifications in a scope of the present invention. Also, the respective exemplary embodiments can be realized separately or in combination.

This patent application claims a priority based on Japanese patent application No. 2009-227430 filed on Sep. 30, 2009, and the disclosure thereof is incorporated herein by reference.

What is claimed is:

1. A charging system comprising:
a communication network;
a charging server apparatus configured to charge a communication on said communication network;
wherein said charging server apparatus stores charge class data used to calculate a charged fee to the communication for every user; and
a management server apparatus configured to determine a network route for the communication, sets route information for said network route to network switches on said network route in said communication network,
wherein said management server apparatus sets said charges class data for the user as well as the route information to one of said network switches as a charging network switch,
wherein said charging network switch performs the charge calculation by using said charge class data every time a packet for said communication is transferred, to generate charged fee data, and
wherein when said communication ends, said management server apparatus acquires said charged fee data from said charging network switch to transmits to said charging server apparatus.

2. The charging system according to claim 1, wherein said management server apparatus selects an optional one from said network switches as said charging network switch.

3. The charging system according to claim 1, wherein said management server apparatus selects all of said network switches as said charging network switches.

4. The charging system according to claim 3, wherein said management server apparatus stores data indicating all of said charging network switches to which said charge class data is set, for every user, calculates a total of said changed fee data acquired from said charging network switches for every said user when said communication ends, and transmits the total changed fee data for every user to said charging server apparatus, when said communication completes in all of said charging network switches.

5. The charging system according to claim 1, wherein said charge class data indicates a fee charged per a packet or a byte in the communication.

6. The charging system according to claim 1, wherein said management server apparatus changes said charge class based on communication quality in said network route, and sets the charge class data to said charging network switch.

7. The charging system according to claim 1, wherein said charging network switch changes the charge class data set based on a performance of said charging network switch.

8. The charging system according to claim 1, wherein said charging network switch comprises:
a storage unit storing a flow table which retains said route information, said charge class data, said charged fee data, and data of a communication flow which uniquely specifies said communication;
a switch section configured to transfer the packet based on said flow table; and
a charge processing section configured to perform the charge calculation by using said charge class data every time the packet for said communication is transferred to generate the charged fee data, and store a result of the charge calculation in said flow table.

9. The charging system according to claim 1, wherein said management server apparatus comprises:
a route solving section configured to determine said network route based on data of a communication flow of said communication and determine said charging network switch;
a user managing section configured to specify the user of said communication based on said communication flow data;
a charge class solving section configured to acquire said charge class data for said user specified by said user managing section, from said charging server apparatus; and
a communication managing section configured to select one of said network switches as said charging network switch, set said route information to said network switches other than said selected network switch and set said route information and said charge class data to said charging network switch.

10. A charging method in The charging system comprises a communication network, and a charging server apparatus configured to charge a communication on said communication network, wherein said charging server apparatus stores charge class data used to calculate a charged fee for said communication for every user, and a management server apparatus configured to determine the network route of said communication, set route information for said network route to network switches on said network route in said network,
said charging method comprising:
selecting at least one of said network switches as a charging network switch;
setting said charge class data for the user and said route information to said charging network switch;
performing the charge calculation by using said charge class data every time transferring a packet for said communication, to generate the charged fee data; and
acquiring the charged fee data from said charging network switch when said communication ends, and transmitting the charged fee data to said charging server apparatus.

11. The charging method according to claim 10, wherein said selecting at least one of said network switches comprises:
selecting at least one optional from said network switches as said charging network switch.

12. The charging method according to claim 10, wherein said selecting at least one of said network switches comprises:
selecting all of said network switches as said charging network switches.

13. The charging method according to claim 12, further comprising:
storing data of all said charging network switches to which said charge class data is set, for every user of said communication,
wherein said transmitting the charged fee data comprises:
totalizing every user by acquiring said charged fee data from said charging network switch when said communication ends; and
transmitting a total value of the changed fee data for every user when said communication completed in all said charging network switches, to said charging server apparatus.
